(19) United States
(12) Patent Application Publication
(10) Pub. No.: US 2021/0395425 A1
(43) Pub. Date: Dec. 23, 2021

(54) CAUSTIC WASHABLE COMPOSITIONS FOR PRINTING

(71) Applicant: INX International Ink Co., Schaumburg, IL (US)

(72) Inventors: Eli Kendra, Schaumburg, IL (US); Jonathan Graunke, Schaumburg, IL (US)

(21) Appl. No.: 17/350,834

(22) Filed: Jun. 17, 2021

Related U.S. Application Data
(60) Provisional application No. 63/041,011, filed on Jun. 18, 2020.

(51) Int. Cl. C08F 265/06; C08L 33/08; C08L 33/14; C08L 75/16; C09D 11/101; C09D 5/00; C09D 11/107; C09D 151/00; C09D 151/08; B41M 1/04; B41M 1/30; B41M 5/00; B41M 7/00

(52) U.S. Cl. CPC C08F 265/06; C08L 33/08; C08L 33/14; C08L 75/16; C09D 11/101; C09D 5/002; C08L 2205/025; C09D 151/003; C09D 151/08; B41M 1/04; B41M 1/30; B41M 5/0017; B41M 7/0081; C09D 11/107

(57) ABSTRACT

An actinic radiation curable composition comprising a carboxylated acrylate, a urethane acrylate, a monomer, and a photoinitiator is disclosed herein, which both provides satisfactory adhesion to a substrate surface and may be effectively removed by caustic wash. Also provided is a method of printing, comprising applying an actinic radiation curable composition as disclosed herein onto a surface of a substrate, curing the applied composition, and applying an ink on the cured composition.

### CROSS-REFERENCE TO RELATED APPLICATIONS

This patent application claims priority to U.S. Provisional Patent Application No. 63/041,011, filed on Jun. 18, 2020, the content of which is incorporated herein by reference in its entirety.

### BACKGROUND

Printable compositions such as inks, primers, and coatings are widely used for labeling and packaging of commercial products. In general, the printable composition needs to have strong adhesion to a substrate surface. On the other hand, one challenge in recycling packaging materials is the effective removal of the printed colors, labels, and/or coatings from the substrate material. It is desirable for a printable composition, such as an ink or a primer, to both provide good adhesion to a substrate surface (e.g., a plastic surface) and be removable by caustic wash, such that the substrate can be safely recycled. Thus, there remains a need for effective printable products, such as energy curable inks and primers that satisfy both requirements.

### SUMMARY

In one aspect, the present disclosure provides an actinic radiation curable composition useful for printing applications, which both has satisfactory adhesion to a substrate surface and may be effectively removed by caustic wash.

In one embodiment, provided is an actinic radiation curable composition comprising a carboxylated acrylate, a urethane acrylate, a monomer, and a photoinitiator, wherein the composition, when applied onto a surface and cured, (1) maintains at least 80% adhesion to the surface in a tape adhesion test and (2) is at least 80% removed from the surface by a caustic wash.

In another embodiment, provided is an actinic radiation curable composition, comprising by weight

about 35% to about 55% a carboxylated acrylate,

about 15% to about 45% an urethane acrylate,

about 5% to about 15% a monomer,

about 2% to about 10% an adhesion promoter, and

about 5% to about 15% a photoinitiator.

In another aspect, the present disclosure provides a method of printing, comprising applying an actinic radiation curable composition as disclosed herein onto a surface of a substrate, curing the applied composition, and applying an ink on the cured composition.

### DETAILED DESCRIPTION

The present disclosure relates to actinic radiation curable compositions suitable for printing applications. Remarkably, the present compositions may provide both satisfactory adhesion to a substrate surface and effective removability during a caustic wash. Because of their advantageous adhesion and caustic removability properties, the compositions may be particularly useful for ink printing and de-inking applications for recyclable plastic substrates.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “actinic radiation” as used herein includes all electromagnetic radiation that induces a chemical reaction, such as a polymerization reaction between the curable compounds described herein. Suitable actinic radiations include, but are not limited ultraviolet (UV) radiation, light-emitting diode (LED) radiation, electronic beam (EB) radiation, and other emission or transmission of energy in the form of waves or particles through space or a material medium.

The term “actinic radiation curable” as used herein refers to curing in response to exposure to suitable actinic radiation, such as UV radiation, LED radiation, and EB radiation.

The term “cure” or “curing” as used herein refers to a process that leads to polymerizing, hardening and/or cross-linking of monomer and/or oligomer units to form a polymer.

The term “monomer” as used herein, refers to a material having a viscosity less than that of an oligomer, molecular weight of less than 1000 g/mole or about 1000 g/mole and viscosity of less than 500 cps or about 500 cps at 25° C. The monomers may contain one or more unsaturated groups capable of polymerizing to form oligomers or polymers.

The term “oligomer” as used herein refers to a material having a viscosity greater than that of a monomer and a molecular weight of about 5000 g/mole to 200,000 g/mole, which is capable of polymerizing to form polymers with higher molecular weight. The oligomer may cure upon application of UV, LED or EB radiation.

The term “caustic wash” refers to a process in which an ink, mark, or label printed on a substrate surface is partially or completely removed by contacting the substrate surface with an aqueous solution of a strong base. For example, an ink composition may be printed onto a plastic substrate surface to form of a printed film, which may be partially or completely removed by contacting the surface with an aqueous caustic solution as described herein. the printed film within some embodiments, the caustic wash may be a standard caustic wash process according to The Association of Plastic Recyclers (APR), which is suitable for recycling plastic materials. See, for example, APR Document Number PET-P-00, section PET-P-04 (available at https://plasticsrecycling.org/images/pdf/design-guide/test-methods/PET_Practices_PET-P-00.pdf). The caustic wash may be conducted in an aqueous solution comprising at least 0.1% by weight, at least 0.5% by weight, or at least 1.0% by weight a strong base, such as sodium hydroxide or potassium hydroxide. The aqueous solution may further comprise at least 0.1% by weight, at least 0.3% by weigh, or at least 0.5% by weight a detergent, such as Triton X-100 nonionic surfactant. In some embodiments, the caustic wash is conducted in an aqueous solution comprising about 0.3% by weight a detergent and about 1% by weight sodium hydroxide. The caustic wash may be conducted under stirring and at an elevated temperature. For example, the temperature may be about 60° C., about 65° C., about 70° C., about 75° C., about 80° C., or about 85° C., or about 90° C. In some embodiments, the caustic wash is conducted under stirring at a temperature of about 85° C.

The term “tape adhesion test” refers to a measurement of adhesion level of a composition applied to a surface. Suitable test methods include those well known in the art. Typically, an adhesive tape is applied to the composition after the composition is applied to the surface and cured, and the tape is then pulled off. The “adhesion level” is measured by the amount of the composition remaining on the substrate after the tape is pulled off. For example, an “80% adhesion” as demonstrated by a tape adhesion test means that 80% of the applied composition remains adhering to the substrate surface.

Composition

In one aspect, the present disclosure provides an actinic radiation curable composition useful for printing applications. In particular, the actinic radiation curable composition may be used as a primer composition that imparts caustic washability to energy curable ink systems. Remarkably, the present primer composition may allow for ink adhesion to a recyclable plastic substrate (e.g., a plastic film), may be resistant to steam/heat treatment employed in the shrink packaging system to ensure proper handling of the substrate and label lines, and may be removable using a standard caustic wash method suitable for recycling purposes, such as those according to APR standard processes.

The present actinic radiation curable compositions may be advantageous over the known water and/or solvent based primers and fully compatible with energy curable inks. In particular, lab testing has shown faster curing and good adhesion and printability of energy curable ink on top of the present primers.

In a first embodiment, the present disclosure provides an actinic radiation curable composition comprising a carboxylated acrylate, a urethane acrylate, a monomer, and a photoinitiator, wherein the composition, when applied onto a surface and cured, (1) maintains at least 80% adhesion to the surface in a tape adhesion test and (2) is at least 80% removed from the surface by a caustic wash.

In a second embodiment, the present disclosure provides an actinic radiation curable composition, comprising by weight

about 35% to about 55% a carboxylated acrylate,

about 15% to about 45% an urethane acrylate,

about 5% to about 15% a monomer,

about 2% to about 10% an adhesion promoter, and

about 5% to about 15% a photoinitiator.

The compositions of the second embodiment, when applied onto a surface and cured, may (1) maintain at least 80% adhesion to the surface in a tape adhesion test and (2) be at least 80% removed from the surface by a caustic wash.

The surface as described herein may comprise a plastic material. In some embodiments, the surface comprises polyethylene terephthalate (PET), high-density polyethylene (HDPE), low-density polyethylene (LDPE) polyvinyl chloride (PVC), polypropylene (PP), polystyrene (PS), polycarbonate (PC), or a combination thereof. In some embodiments, the surface comprises crystallizable polyethylene terephthalate (CPET).

The adhesion level may be at least 80% adhesion, at least 85% adhesion, at least 90% adhesion, at least 95% adhesion, or even at least 99% adhesion as demonstrated by a tape adhesion test as described herein.

The present actinic radiation curable compositions, when applied onto the surface and cured, may be at least 80% removed, at least 85% removed, at least 90% removed, at least 95% removed, or even at least 99% removed from the surface by the caustic wash as described herein.

The present actinic radiation curable compositions may have a viscosity of about 200 cps to about 1000 cps at 25° C. The viscosity of the compositions may be at least 200 cps, at least 400 cps, at least 600 cps, or at least 800 cps at 25° C. The viscosity of the compositions may be at most 900 cps, at most 700 cps, at most 500 cps, or at most 300 cps at 25° C. In some embodiments, the viscosity of the compositions is about 200 cps to about 800 cps, about 200 cps to about 600 cps, or about 400 cps to about 800 cps at 25° C.

The present actinic radiation curable compositions may comprise about 35% to about 55% by weight a carboxylated acrylate. The compositions may comprise at least 35%, at least 40%, at least 45%, or at least 50% by weight the carboxylated acrylate. The compositions may comprise at most 55%, at most 50%, at most 45%, or at most 40% by weight the carboxylated acrylate. In some embodiments, the present compositions comprise about 35%, about 40%, about 45%, about 50%, or about 55% by weight the carboxylated acrylate. In some embodiments, the present compositions comprise about 35% to about 45% by weight the carboxylated acrylate.

Suitable carboxylated acrylates include, but are not limited to, various carboxylated polyester acrylate oligomers. These compounds may have carboxyl group (—COOH) attached to the terminals or backbone of the polymer or oligomer. The carboxylated acrylate may be alkali strippable or removable under alkali conditions. The carboxylated acrylate may have an acid value of about 100 mg KOH/g to about 300 mg KOH/g, such as about 150 mg KOH/g to about 300 mg KOH/g, about 200 mg KOH/g to about 280 mg KOH/g, or about 240 mg KOH/g to about 270 mg KOH/g. In some embodiments, the carboxylated acrylate has an acid value of about 150 mg KOH/g, about 200 mg KOH/g, about 250 mg KOH/g, or about 270 mg KOH/g. The carboxylated acrylate may have a viscosity of about 200 cps to about 50000 cps at 25° C., such about 200 cps to about 30000 cps, about 200 cps to about 10000 cps, or about 200 cps to about 6000 cps at 25° C.

Suitable carboxylated polyester acrylate oligomers include, for example, those commercially available from Double Bond Chemical (Taiwan) Co., Ltd. under the product name DOUBLEMER 272 (acid value 200 mg KOH/g, viscosity 10,000-30,000 cps at 25° C.), from Soltech Ltd. under the product name SP 270 (acid value 200 mg KOH/g, viscosity of 1500 cps at 25° C.), SP 271 (acid value 180 mg KOH/g, viscosity of 14000 cps at 25° C.), SP 277 (acid value 200 mg KOH/g, viscosity of 6500 cps at 25° C.), from Allnex under product name EBECRYL 170 (acid value 270-330 mg KOH/g, viscosity of 3000 cps at 25° C.), from Miwon Specialty Chemical Co., Ltd. under the product name Miramer SC6640 (acid value 240-270 mg KOH/g, viscosity of 200 cps at 25° C.). In particular embodiments, the carboxylated acrylates include alkali strippable polyester acrylates, such as Miramer SC6640.

The present actinic radiation curable compositions may comprise about 15% to about 45% by weight an urethane acrylate. The compositions may comprise at least 15%, at least 20%, at least 25%, at least 30%, at least 35%, or at least 40% by weight the urethane acrylate. The compositions may comprise at most 45%, at most 40%, at most 35%, at most 30%, at most 25%, or at most 20% by weight the urethane acrylate. In some embodiments, the present compositions comprise about 20%, about 25%, about 30%, about 35%, or about 40% by weight the urethane acrylate. In some embodiments, the present compositions comprise about 25% to about 40% by weight the urethane acrylate.

Suitable urethane acrylates include, but are not limited to, various urethane (meth)acrylate oligomers. The urethane acrylates may have molecular weight of less than about 75000 g/mole and viscosity of less than about 50000 cps at 25° C. For example, the urethane (meth)acrylate oligomers may have a molecular weight of about 500 g/mole to about 50000 g/mole and a viscosity of about 100 cps to about 40000 cps at 25° C. at room temperature. The urethane acrylate may be an aromatic urethane acrylate, an aliphatic urethane acrylate, or a combination thereof. Suitable urethane acrylates include monofunctional, difunctional, trifunctional, tetrafunctional, pentafunctional, hexafunctional compounds, or combinations thereof.

Suitable aromatic urethane (meth)acrylate oligomers include, but are not limited to, those commercially available from Sartomer Chemical Co. under the product names CN-131, CN9782, CN9783, CN992, CN975, and CN972, or commercially available from Rahn Corp. under the product names Genomer 4622 and Genomer 4217. Suitable aliphatic urethane (meth)acrylate oligomers include, but not limited to, those commercially available from Sartomer Chemical Co. under the product names CN9004, CN9005, CN9006, CN9023, CN9028, CN9178, CN969, CN9788, CN986, CN989, CN9893, CN996, CN2920, CN3211, CN9001, CN9009, CN9010, CN9011, CN9071, CN9070, CN929, CN962, CN9025, CN9026, CN968, CN965, CN964, CN991, CN980, CN981, CN983, CN9029, CN9030, CN9031, CN9032, CN9039, CN9018, CN9024 and CN9013, or those commercially available from Rahn Corp. under the product names Genomer 4188, Genomer 4215, Genomer 4230, Genomer 4267, Genomer 4269, Genomer 4312, Genomer 4316, Genomer 4425, Genomer 4590 and Genomer 4690. Other suitable urethane (meth)acrylate oligomers include those commercially available from Miwon Specialty Chemical Co. under product name Miramer PU2552 and Miramer PU212, or those commercially available from Allnex under product name Ebecryl 271, Ebecryl 242, Ebecryl 1291, Ebecryl 4100, Ebecryl 4200, Ebecryl 5129, Ebecryl 8210, Ebecryl 8296, Ebecryl 8402, Ebecryl 8411, Ebecryl 8465, Ebecryl 8604, Ebecryl 220, Ebecryl 4500 and Ebecryl 4849. In some embodiments, the urethane acrylates include commercially available aromatic urethane acrylates (e.g., RAHN GENOMER 4622), aliphatic urethane acrylates (e.g., MIWON MIRAMER PU2552, MIWON MIRAMER PU212), or a combination thereof. Various other types of urethane acrylates may be used. Suitable urethane acrylate products may vary, for example, in the diluting agents used to reduce the viscosity of the urethane.

The present actinic radiation curable compositions may comprise about 5% to about 25% by weight a monomer. The compositions may comprise at least 5%, at least 10%, at least 15%, or at least 20% by weight the monomer. The compositions may comprise at most 25%, at most 20%, at most 15%, or at most 10% by weight the monomer. In some embodiments, the present compositions comprise about 5%, about 8%, about 10%, about 12%, about 15%, or about 20% by weight the monomer. In some embodiments, the present compositions comprise about 5% to about 15% by weight the monomer.

Suitable monomers include, but are not limited to, mono-functional monomers, difunctional monomers, trifunctional monomers, tetrafunctional monomers, or a combination thereof. Suitable monomers include, for example, 2-(2-ethoxyethoxy) ethyl acrylate (EOEOEA), propoxylated neopentyl glycol diacrylate (PONPGDA), ethoxylated 1,6-hexandiol diactrylate (EOHDODA), tris (2-hydroxy ethyl) isocyanurate triacrylate (THEICTA), trimethylolpropane triacrylate (TMPTA), or a combination thereof. Suitable monomers include commercially available products, such as SARTOMER SR502 E09 TMPTA, SARTOMER SR351H TMPTA, SARTOMER SR9003B PONPGDA, or IGM PHOTOMER 4172F EOPETA. In some embodiments, the monomer includes free radical polymerization monomers such as propoxylated neopentyl glycol diacrylate (PONPGDA). Various other types of known monomers may be used.

The present actinic radiation curable composition may comprise about 5% to about 15% by weight a photoinitiator. The compositions may comprise at least 5%, at least 8%, at least 10%, or at least 12% by weight the photoinitiator. The compositions may comprise at most 15%, at most 12%, at most 10%, at most 8%, or at most 6% by weight the photoinitiator. In some embodiments, the present compositions comprise about 5%, about 8%, about 10%, about 12%, or about 15% by weight the photoinitiator. In some embodiments, the present compositions comprise about 6% to about 10% by weight the photoinitiator.

Various known photoinitiators may be used, and the present actinic radiation curable composition may be cured under various light sources, including but not limited to mercury bulb, LED, energy beam, or long wavelength lamp. Suitable photoinitiators include, for example, commercially available diphenyl(2,4,6-trimethylbenzoyl)phosphine oxide (TPO), 2-hydroxy-2-methylpropiophenone (HMPP), 1-hydroxycyclohexyl phenyl ketone (HCPK), and a combination thereof.

The present actinic radiation curable composition may further comprise at least one additional component selected from an adhesion promoter, a matting agent, a stabilizer, and a defoamer.

The adhesion promoter may increase the adhesion between the actinic radiation curable composition and a substrate to which the composition is applied. The actinic radiation curable composition may comprise about 2% to about 10% by weight an adhesion promoter. The compositions may comprise at least 2%, at least 4%, at least 6%, or at least 8% by weight the adhesion promoter. The compositions may comprise at most 10%, at most 8%, at most 6%, or at most 4% by weight the adhesion promoter. In some embodiments, the present compositions comprise about 4%, about 6%, about 8%, or about 10% by weight the adhesion promoter. In some embodiments, the present compositions comprise about 6% to about 10% by weight the adhesion promoter. Suitable adhesion promoters may include a polymerizable group, such as a vinyl group. In some embodiments, the adhesion promoter is considered as a monomer in the present ink composition. In some embodiments, the ink composition comprises a monomer (such as an acrylate monomer) as described herein and an adhesion promoter that is different from the monomer. Suitable adhesion promoters include, but are not limited to, N-vinyl-2-caprolactam, N-vinyl-2-pyrrolidone, and a combination thereof. Commercially available adhesion promoters include, for example, V-Pyro1™ RC and V-Cap™ RC (Ashland).

The present actinic radiation curable compositions may comprise about 0.1% to about 2% by weight a matting agent. Suitable matting agents include, for example, commercially available precipitated silica products.

The present actinic radiation curable compositions may comprise about 0.1% to about 2% by weight a stabilizer. Suitable stabilizers include, for example, commercially available products under XAMCHEM XC-SB302.

The present actinic radiation curable compositions may comprise about 0.05% to about 0.5% by weight a defoamer. Suitable defoamer include, for example, commercially available products under Evonik 971.

Method

In another aspect, the present disclosure provides a method of printing, comprising applying an actinic radiation curable composition as disclosed herein onto a surface of a substrate,

curing the applied composition, and

applying an ink on the cured composition.

Advantageously, the actinic radiation curable composition used in the present methods, when applied onto a surface and cured, may maintain at least 80% adhesion to the surface in a tape adhesion test, and may be at least 80% removed from the surface by a caustic wash. Thus, the present printing method may be particularly beneficial for decorating or labeling recyclable substrate, as the printed composition and ink may be conveniently removed by caustic wash to facilitate the recycling of the substrate.

In some embodiments, the ink is an actinic radiation curable ink. For example, the ink may comprise a formulation that is curable by UV, LED, or EB radiations. In these embodiments, the present method may further comprise a step of curing the applied ink.

The actinic radiation curable composition may be applied onto an entire area or a partial area of a substrate surface. The surface may include an outer surface, an inner surface, or both, of the substrate. The surface or the area on the surface to which the composition is applied may be any shape or size.

The substrate may comprise a recyclable material, such as plastic materials. In some embodiments, the substrate is a plastic substrate, including a substrate made of recyclable plastics. In some embodiments, the substrate comprises plastic and at least one other material, such as metal, alloy, paper, porcelain, or a combination thereof. For example, the substrate may be a container, such as a bottle, a can, ajar, or a box, made of recyclable plastics.

The substrate surface to which the actinic radiation curable composition is applied may comprises a recyclable material, such as plastic materials. For example, the surface may comprise a wall of a plastic substrate, or a plastic layer on a substrate that includes at least one other material, such as metal, alloy, paper, porcelain, or a combination thereof.

In some embodiments, the substrate surface to which the actinic radiation curable composition is applied comprises polyethylene terephthalate (PET), high-density polyethylene (HDPE), low-density polyethylene (LDPE) polyvinyl chloride (PVC), polypropylene (PP), polystyrene (PS), polycarbonate (PC), or a combination thereof. In some embodiments, the substrate surface to which the actinic radiation curable composition is applied comprises crystallizable polyethylene terephthalate (CPET).

The present actinic radiation curable composition may be applied by known printing methods, such as flexographic processes. In some embodiments, the present composition is applied as a primer composition. For example, the present composition may be applied as a primer composition in a flexographic process by known techniques. The applied primer may be cured, for example, using UV light (200 nm-400 nm range). Once the primer is cured, suitable, commercially available UV flexographic or offset lithography inks may be printed on top of the primer. These inks may be cured using appropriate known methods for their process.

The present actinic radiation curable composition also may be adapted for use in various other print methods, such as digital and offset printing. For example, the present composition may be adjusted to prepare a low viscosity and jettable composition for use as a primer in digital printing. The present composition also may be adapted for use as an offset primer, which may be either applied in a coating unit at the beginning of the press or converted into a first down varnish layer. Suitable printing processes also may include screen or gravure processes as known in the art. In some embodiments, the present composition is applied via jetting (e.g., for low viscosity jettable primers) or applied as a coating (e.g. for offset primers).

The actinic radiation curable composition applied to the substrate surface may form a film or membrane on the surface. In some embodiments, the applied composition forms a film on the substrate surface having a thickness of about 2 μm to about 25 μm. The thickness may be about 5 μm, about 10 μm, about 15 μm, or about 20 μm.

### Examples

Formulations of the present primer were prepared and tested according to the following examples. Printed samples were prepared for each example by applying a primer formulation to shrink plastic packaging materials via a flexographic process, curing the primer formulation via UV light and printing a flexographic UV ink on top of the primer. The printed samples were shrunk by steam, which was accomplished by holding the samples over a beaker of boiling water. The samples were allowed to shrink by about 75%. Once shrunk, the samples were checked for adhesion via tape testing and fingernail scratch testing.

Tape adhesion was measured using commercial tape products (e.g., 3M 610, 3M 810) as a quality test for the primer formulations. Typically, a primer and then an ink were applied to a substrate to form a print, a tape was applied to the print, and the tape was then pulled off. The “adhesion level” of the primer was measured by visual estimation of the percentage of the ink remaining on the substrate (through adhesion to the primer) after the tape was pulled off. For example, an “80% adhesion” in a tape adhesion test as described herein means that approximately 80% of the ink remains adhering to the primer on the substrate as estimated by visual examination. An adhesion level of 90-100% as measured by the tape adhesion test is considered acceptable or good adhesion, and an adhesion level of 50% or less is considered weak or poor adhesion, for the primer formulation disclosed herein.

The printed samples were also tested using a caustic wash method adapted from the procedures set forth by the APR. Typically, a printed sample (e.g. a shrank plastic label) was washed in a hot aqueous caustic, detergent solution. The caustic solution may include, for example, Triton X-100 nonionic surfactant (about 0.3% by weight) and sodium hydroxide (about 1% by weight). The printed sample was placed in the caustic solution at a sample to solution weight ratio of about 1:4, and the solution was then agitated (e.g., using an impellor at an impellor tip speed of at least 240 meters per minute) for 15 minutes at 85° C. In some tests, the printed sample was granulated into plastic flakes prior to contacting the caustic solution. The washed sample was then rinsed with water (4 times the weight of the sample) at 45° C. under agitation (e.g., at an impellor tip speed of at least 240 meters per minute) for about 5 minutes. The rinsed sample was further rinsed with water (8-10 times the weight of the sample) with mild agitation and recovered. The recovered sample was dried by air or in a lab oven at a temperature of 60° C. or lower. The sample was then visually examined to estimate the amount of the remaining ink on the sample. For example, a washed sample having approximately 20% or less ink remaining indicates that approximately 80% or more of the ink printed on the sample was removed by the caustic wash process. A “pass” in the caustic wash tests as described herein refers to at least 85% of the ink is removed by the caustic wash process.

Formulation 1A

| Material Name | Wt. % | Description |
|---|---|---|
| ALLNEX EB436 POLY Oligomer IN | 49.5% | Chlorinated |
| TMPTA (C) | | Polyester |
| ALKOXYLATED THF ACRYLATE | 5.0% | Acrylated THF |
| EOHDODA | 20.0% | Monomer |
| EOEOEA | 16.0% | Monomer |
| TPO | 4.0% | Photoinitiator |
| HMPP | 4.0% | Photoinitiator |
| HCPK | 1.0% | Photoinitiator |
| XAMCHEM XC-SB302 | 0.5% | Stabilizer |

Formulation 1B

| Material Name | Wt. % | Description |
|---|---|---|
| SARTOMER CN2285 ACRYLIC | 89.5 | Acrylic Oligomer |
| OLIGOMER BLEND | | |
| ETERNAL ETERCURE 6328 | 4 | Polyester Acrylate Oligomer |
| AALCHEM PI-TPO | 2 | Photoinitiator |
| JURI JRCURE OMBB | 4 | Photoinitiator |
| BASF IRGANOX 1076 UV | 0.5 | Thermal Stabilizer |
| STABILIZER | | |

Formulation 1C

| Material Name | Wt. % | Description |
|---|---|---|
| ETERNAL ETERMER 2380IX EO3TMPTA | 61.57 | Monomer |
| RAHN GENOMER 3364 | 12.94 | Polyester/polyether |
| | | acrylate Oligomer |
| AGI AGISYN 008 ACRYLATED AMINE | 14.93 | Acrylated Amine |
| RAHN GENOPOL BP2 | 5.97 | Photoinitiator |
| AALCHEM PI TPO-L | 1 | Photoinitiator |
| IGM OMNIRAD 754 PHOTOINITIATOR | 2.99 | Photoinitiator |
| CINCOL OB | 0.5 | Optical Brightener |
| AALCHEM IN 510 | 0.1 | Thermal Stabilizer |

Formulation 1D

| Material Name | Wt. % | Description |
|---|---|---|
| SARTOMER SR531 ACRYLATE | 41.5 | Monomer |
| SARTOMER SR9003B PONPGDA | 7 | Monomer |
| MONOMER | | |
| SARTOMER CN9024 URETHANE | 20 | Urethane Acrylate |
| ACRYLATE | | Oligomer |
| SARTOMER CN9002 | 17.5 | Aliphatic Urethane |
| | | Acrylate Oligomer |
| LUBRIZOL CC7610 POLYETHYLENE | 2 | Polyethylene Wax |
| WAX DISPERS | | |
| EVONIK TEGO AIREX 920 | 0.1 | Defoamer |
| DEFOAMER | | |
| RAHN GENORAD 26 | 0.3 | Thermal Stabilizer |
| AALCHEM PI - 184 | 4 | Photoinitiator |
| AALCHEM PI-TPO | 3 | Photoinitiator |
| AALCHEM PI-907 | 3 | Photoinitiator |
| AGI AGISYN 008 ACRYLATED | 3.6 | Acrylated Amine |
| AMINE | | |

The above primer formulations were prepared and tested using the caustic wash method as described herein. The testing revealed that none of these formulations were removed during the caustic wash.

Formulation 2

| Material Name | Wt. % | Description |
|---|---|---|
| Miramer SC6640 | 90.5% | Carboxylated acrylate |
| TPO | 4.0% | Photoinitiator |
| HMPP | 4.0% | Photoinitiator |
| HCPK | 1.0% | Photoinitiator |
| XAMCHEM XC-SB302 | 0.5% | Stabilizer |

The above primer formulation was prepared using commercially available carboxylated polyester acrylate Miramer SC6640 (Miwon), which is specifically designed to be alkali strippable. However, it was discovered that this primer formulation does not provide sufficient adhesion and the primer and ink could be removed during the shrinking process for the printed shrink plastic packaging materials.

Formulations 3-9

| | Formulation | Formulation | Formulation | Formulation | |
|---|---|---|---|---|---|
| | 3 | 4 | 5 | 6 | |
| Material Name | Wt. % | Wt. % | Wt. % | Wt. % | Description |
| Miramer SC6640 | 60.5 | 60.5 | 60.5 | 60.5 | Carboxylated acrylate |
| Rahn Genomer | 10 | 10 | 10 | 10 | Epoxy Acrylate |
| 2259 | | | | | |
| TMPTA | 20 | | | | Monomer |
| V-Pyrol | | | | 3 | Adhesion Promoter |
| THEICTA | | | 5 | | Monomer |
| EB450 | | | | | Polyester Acrylate |
| THFA | | | | | Adhesion Promoter |
| PONPGDA | | 20 | 15 | 17 | Monomer |
| Precipitated Silica | | | | | Matting Agent |
| TPO | 4 | 4 | 4 | 4 | Photoinitiator |
| HMPP | 4 | 4 | 4 | 4 | Photoinitiator |
| HCPK | 1 | 1 | 1 | 1 | Photoinitiator |
| XAMCHEM | 0.5 | 0.5 | 0.5 | 0.5 | Stabilizer |
| XC-SB302 | | | | | |

| | Formulation 7 | Formulation 8 | Formulation 9 | |
|---|---|---|---|---|
| Material Name | Wt. % | Wt. % | Wt. % | Description |
| Miramer SC6640 | 60.5 | 55.5 | 55 | Carboxylated acrylate |
| Rahn Genomer 2259 | 10 | 10 | 10 | Epoxy Acrylate |
| TMPTA | | | | Monomer |
| V-Pyrol | 3 | 3 | 3 | Adhesion Promoter |
| THEICTA | | | | Monomer |
| EB450 | | 10 | 10 | Polyester Acrylate |
| THFA | 5 | | | Adhesion Promoter |
| PONPGDA | 12 | 12 | 12 | Monomer |
| Precipitated Silica | | | 0.5 | Matting Agent |
| TPO | 4 | 4 | 4 | Photoinitiator |
| HMPP | 4 | 4 | 4 | Photoinitiator |
| HCPK | 1 | 1 | 1 | Photoinitiator |
| XAMCHEM XC-SB302 | 0.5 | 0.5 | 0.5 | Stabilizer |

The above primer formulations were prepared and tested for susceptibility to steam in order to maintain adhesion through the shrinking process. The results from the testing of these formulations are summarized in Table 1.

TABLE 1

| | |
|---|---|
| Formulation 3 | Weak adhesion on hard fold |
| Formulation 4 | Weak adhesion after shrink |
| Formulation 5 | No adhesion before shrink |
| Formulation 6 | No adhesion after ink overprint |
| Formulation 7 | Poor adhesion on hard fold after shrink |
| Formulation 8 | Poor adhesion on hard fold after shrink |
| Formulation 9 | Acceptable adhesion, passes caustic wash test |

Formulation 3-8 showed weak or poor adhesion and were not tested for caustic wash. In contrast, formulation 9 demonstrated acceptable adhesion, was able to be printed and shrank well, and passed the caustic wash test as described herein. The addition of matting agent (precipitated silica) in formulation 9 to some extent improved adhesion level. However, it is believed that the adhesion levels for formulation 9 may be improved by, for example, controlling curing level, volume of primer/ink to be printed, and formulation stock-related variations, to provide consistent results between lab testing and commercial printer settings.

Formulations 10-14

| | Form. | Form. | Form. | Form. | Form. | |
|---|---|---|---|---|---|---|
| | 10 | 11 | 12 | 13 | 14 | |
| Material Name | Wt. % | Wt. % | Wt. % | Wt. % | Wt. % | Description |
| Miramer SC6640 | 55 | 50 | 25 | 10 | 25 | Carboxylated acrylate |
| Rahn Genomer 2259 | 15 | | | | | Epoxy Acrylate |
| RAHN GENOMER 4622 | | | 5 | 10 | 5 | Urethane Acrylate |
| MIWON MIRAMER PU2552 | | 15 | 25 | 29 | 25 | Urethane Acrylate |
| MIWON MIRAMER PU212 | | | 10 | 10 | 10 | Urethane Acrylate |
| V-Pyrol | 3 | 4 | 4 | 4 | 4 | Adhesion Promoter |
| V Cap | | 4 | 4 | 4 | 4 | Adhesion Promoter |
| PONPGDA | 17 | 17 | 17 | 23 | 17 | Monomer |
| Precipitated Silica | 0.5 | 0.5 | 0.5 | 0.5 | | Matting Agent |
| TPO | 4 | 4 | 4 | 4 | 4 | Photoinitiator |
| HMPP | 4 | 4 | 4 | 4 | 4 | Photoinitiator |
| HCPK | 1 | 1 | 1 | 1 | 1 | Photoinitiator |
| XAMCHEM XC-SB302 | 0.5 | 0.5 | 0.5 | 0.5 | 0.5 | Stabilizer |

The above formulations were prepared to test the effect of reduced amount of carboxylated acrylate. It is hypothesized that the moisture from the shrink process may interfere with adhesion. Urethane acrylates were included to increase the flexibility of the primer and in turn increase its adhesion. The results demonstrated that reducing the carboxylate acrylate content may help improve the adhesion after shrink, but not necessarily enough to be considered a pass (e.g., 95% adhesion or better as measured by the tape adhesion test described herein). The results from these formulations are summarized in Table 2.

TABLE 2

| | |
|---|---|
| Formulation 10 | Poor adhesion before shrink |
| Formulation 11 | Poor adhesion after shrink |
| Formulation 12 | Good adhesion after shrink, failed caustic wash |
| | (with ink and last down white) |
| Formulation 13 | Poor ink adhesion over primer |
| Formulation 14 | Poor ink adhesion over primer |

Formulations 15-17

| | Formulation | Formulation | Formulation | |
|---|---|---|---|---|
| | 15 | 16 | 17 | |
| Material Name | Wt. % | Wt. % | Wt. % | Description |
| Miramer SC6640 | 35 | 44 | 53 | Carboxylated acrylate |
| V-Pyrol | 4 | 4 | 4 | Adhesion Promoter |
| PONPGDA | 9.9 | 10 | 8 | Monomer |
| OK412 | 0.5 | 0.5 | 0.5 | Matting Agent |
| TPO | 4 | 4 | 4 | Photoinitiator |
| HMPP | 4 | 4 | 4 | Photoinitiator |
| HCPK | 1 | 1 | 1 | Photoinitiator |
| XAMCHEM XC-SB302 | 0.5 | 0.5 | 0.5 | Stabilizer |
| RAHN GENOMER 4622 | 5 | 5 | 5 | Urethane Acrylate |
| MIWON MIRAMER PU2552 | 22 | 15 | 8 | Urethane Acrylate |
| MIWON MIRAMER PU212 | 10 | 8 | 8 | Urethane Acrylate |
| V Cap | 4 | 4 | 4 | Adhesion Promoter |
| Evonik 971 | 0.1 | | | Defoamer |

The above primer formulations were prepared to test the effect of the content of caboxylated acrylate at about 35% to about 55% by weight. Formulations 15-17 all showed good adhesion, 95% adhesion or better, after shrinkage and passed the caustic wash testing as described herein.

Lab prints were made using formulation 15 as primer and INX UV Flexo Shrink 70 system under commercial printing conditions, which yielded satisfactory results. The lab testing results showed that the primer/ink combination demonstrated good adhesion before and after shrinkage, and that the ink and primer were removed from the substrate when washed according to the APR caustic wash method. Thus, formulations 15-17 may be suitable, for example, as a primer in commercial printing.

Additional formulations containing carboxylated acrylate were developed. Remarkably, it was observed that the present formulations may correct the curl issue that typically occurs when the printed samples are washed, thus increasing the efficiency of the caustic wash.

Formulations 18-24

| | Formulation | Formulation | Formulation | Formulation |
|---|---|---|---|---|
| | 18 | 19 | 20 | 21 |
| Material Name | Wt. % | Wt. % | Wt. % | Wt. % |
| Miramer SC6640 | 35 | 35 | 35 | 35 |
| V-Pyrol | 4 | 4 | 4 | 4 |
| SARTOMER SR502 EO9 TMPTA | | | | 9.9 |
| SARTOMER SR351H TMPTA | | | 9.9 | |
| MONOMER | | | | |
| SARTOMER SR9003B PONPGDA | 9.9 | 9.9 | | |
| MONOMER | | | | |
| OK412 | 0.5 | 0.5 | 0.5 | 0.5 |
| AALCHEM PI-TPO | 4 | 4 | 4 | 4 |
| ACETO ACETOCURE 73 | 4 | 4 | 4 | 4 |
| AALCHEM PI - 184 | 1 | 1 | 1 | 1 |
| XAMCHEM XC-SB302 | 0.5 | 0.5 | 0.5 | 0.5 |
| RAHN GENOMER 2259 EPOXY | | 10 | | |
| ACRYLATE | | | | |
| RAHN GENOMER 4622 AROMATIC | 10 | | 10 | 10 |
| URETHANE | | | | |
| MIWON MIRAMER PU2552 | 22 | 22 | 22 | 22 |
| MIWON MIRAMER PU212 | 5 | 5 | 5 | 5 |
| V Cap | 4 | 4 | 4 | 4 |
| Evonik 971 | 0.1 | 0.1 | 0.1 | 0.1 |

| | Formulation | Formulation | Formulation |
|---|---|---|---|
| | 22 | 23 | 24 |
| Material Name | Wt. % | Wt. % | Wt. % |
| Miramer SC6640 | 35 | 35 | 35 |
| V-Pyrol | 4 | 4 | 4 |
| IGM PHOTOMER 4172F EOPETA | 5 | 9.9 | 7.5 |
| SARTOMER SR9003B PONPGDA MONOMER | 4.9 | | 2.4 |
| OK412 | 0.5 | 0.5 | 0.5 |
| AALCHEM PI-TPO | 4 | 4 | 4 |
| ACETO ACETOCURE 73 | 4 | 4 | 4 |
| AALCHEM PI - 184 | 1 | 1 | 1 |
| XAMCHEM XC-SB302 | 0.5 | 0.5 | 0.5 |
| RAHN GENOMER 4622 AROMATIC URETHANE | 10 | 10 | 10 |
| MIWON MIRAMER PU2552 | 22 | 22 | 22 |
| MIWON MIRAMER PU212 | 5 | 5 | 5 |
| V Cap | 4 | 4 | 4 |
| Evonik 971 | 0.1 | 0.1 | 0.1 |

As shown in Table 3, Formulation 24 showed good adhesion and very little curl during the wash cycle in lab tested. Additionally, the primer had excellent adhesion during the shrink process. This formulation was then submitted for press testing. Testing on press showed similar results to lab testing with some minor curling during the wash cycle, which trapped ink particles within curled pieces of plastic. As a result, 92% of the printed ink was removed from the substrate after caustic wash.

TABLE 3

| | |
|---|---|
| Formulation 18 | Minor curl during wash cycle |
| Formulation 19 | Samples severely curled during wash cycle |
| Formulation 20 | Samples severely curled during wash cycle |
| Formulation 21 | Samples severely curled during wash cycle |
| Formulation 22 | Minor curl during wash cycle |
| Formulation 23 | Minor curl during wash cycle and Poor adhesion |
| Formulation 24 | Minimal curl with good adhesion before wash cycle |

Formulations 25-26

| | Formulation 25 | Formulation 26 |
|---|---|---|
| Material Name | Wt. % | Wt. % |
| Miramer SC6640 | 45 | 40 |
| V-Pyrol | 4 | 4 |
| IGM PHOTOMER 4172F EOPETA | 9.5 | 9.5 |
| OK412 | 0.5 | 0.5 |
| AALCHEM PI-TPO | 4 | 4 |
| ACETO ACETOCURE 73 | 4 | 4 |
| AALCHEM PI - 184 | 1 | 1 |
| XAMCHEM XC-SB302 | 0.5 | 0.5 |
| RAHN GENOMER 4622 AROMATIC | 10 | 10 |
| URETHANE | | |
| MIWON MIRAMER PU2552 | 12.4 | 17.4 |
| MIWON MIRAMER PU212 | 5 | 5 |
| V Cap | 4 | 4 |
| Evonik 971 | 0.1 | 0.1 |

Both formulations 25 and 26 showed excellent resistance to substrate curl during the wash cycle (Table 4). This allowed for the primer and printed ink to be removed completely (100%). Formulation 25 was adjusted slightly to increase the robustness and scratch resistance. Formulation 26 was further submitted for press testing.

TABLE 4

| | |
|---|---|
| Formulation 25 | No curl with some scratching of shrunk samples |
| Formulation 26 | No curl and scratch resistance increased |

Additionally, a primer according to above formulations 15-26 may be modified for use in various other print methods, such as digital and offset printing. For example, a low viscosity and jettable primer made according to formulations 15-26 may be used as a digital primer. An offset primer made according to formulations 15-26 may be either applied in a coating unit at the beginning of the press or converted into a varnish version. Such a varnish version of the offset primer made according to formulations 15-26 may be made resistant to the fountain solution used in an offset press.

It is understood that the foregoing description and examples are merely illustrative and are not to be taken as limitations upon the scope of the invention. Various changes and modifications to the disclosed embodiments may be made without departing from the spirit and scope the invention.

1. An actinic radiation curable composition comprising a carboxylated acrylate, a urethane acrylate, a monomer, and a photoinitiator, wherein the composition, when applied onto a surface and cured, (1) maintains at least 80% adhesion to the surface in a tape adhesion test and (2) is at least 80% removed from the surface by a caustic wash.

2. The actinic radiation curable composition of claim 1, wherein the composition has a viscosity of about 200 cps to about 1000 cps at 25° C.

3. The actinic radiation curable composition of claim 1, comprising about 35% to about 45% by weight the carboxylated acrylate.

4. The actinic radiation curable composition of claim 1, wherein the carboxylated acrylate has an acid value of about 100 mg KOH/g to about 300 mg KOH/g.

5. The actinic radiation curable composition of claim 1, comprising about 15% to about 45% by weight the urethane acrylate.

6. The actinic radiation curable composition of claim 1, wherein the urethane acrylate is an aromatic urethane acrylate, an aliphatic urethane acrylate, or a combination thereof.

7. The actinic radiation curable composition of claim 1, comprising about 5% to about 25% by weight the monomer.

8. The actinic radiation curable composition of claim 1, wherein the monomer is a monofunctional monomer, a difunctional monomer, a trifunctional monomer, a tetrafunctional monomer, or a combination thereof.

9. The actinic radiation curable composition of claim 1, comprising about 5% to about 15% by weight the photoinitiator.

10. The actinic radiation curable composition of claim 1, wherein the photoinitiator is 2,4,6-trimethylbenzoyldiphenyl phosphine oxide, 2-hydroxy-2-methyl-1-phenyl-1-propanone, 1-hydroxycyclohexyl phenyl ketone, or a combination thereof.

11. An actinic radiation curable composition, comprising by weight
about 35% to about 55% a carboxylated acrylate,
about 15% to about 45% an urethane acrylate,
about 5% to about 15% a monomer,
about 2% to about 10% an adhesion promoter, and
about 5% to about 15% a photoinitiator.

12. The actinic radiation curable composition of claim 11, wherein the composition, when applied onto a surface and cured, (1) maintains at least 80% adhesion to the surface in a tape adhesion test and (2) is at least 80% removed from the surface by a caustic wash.

13. A method of printing, comprising
applying the actinic radiation curable composition of claim 1 onto a surface of a substrate,
curing the applied composition, and
applying an ink on the cured composition.

14. The method of claim 13, wherein the ink is an actinic radiation curable ink, and wherein the method further comprises curing the applied ink.

15. The method of claim 13, wherein the surface comprises plastic.

16. The method of claim 13, wherein the surface comprises polyethylene terephthalate (PET), high-density polyethylene (HDPE), low-density polyethylene (LDPE) polyvinyl chloride (PVC), polypropylene (PP), polystyrene (PS), polycarbonate (PC), or a combination thereof.

17. The method of claim 13, wherein the surface comprises crystallizable polyethylene terephthalate (CPET).

18. The method of claim 13, wherein the composition is applied by a flexographic process.

19. The method of claim 13, wherein the applied composition forms a film having a thickness of about 2 μm to about 25 μm.

20. A method of printing, comprises
applying the actinic radiation curable composition of claim 11 onto a surface of a substrate,
curing the applied composition, and
applying an ink on the cured composition.
